(19) United States
(12) Patent Application Publication
(10) Pub. No.: US 2026/0122021 A1
(43) Pub. Date: Apr. 30, 2026

(54) MESSAGE TRANSMISSION DEVICE

(71) Applicant: NTT DOCOMO, INC., Tokyo (JP)

(72) Inventors: Takeshi YAMASHITA, Chiyoda-ku (JP); Takashi HAMATANI, Chiyoda-ku (JP); Chiaki DOI, Chiyoda-ku (JP); Satoshi HIYAMA, Chiyoda-ku (JP)

(73) Assignee: NTT DOCOMO, INC., Tokyo (JP)

(21) Appl. No.: 18/993,870

(22) PCT Filed: Jun. 6, 2023
(86) PCT No.: PCT/JP2023/021029

§ 371 Date: Jan. 13, 2025

(30) Foreign Application Priority Data
Sep. 8, 2022 (JP) 2022-142998

(51) Int. Cl. H04L 51/216; H04L 51/04

(52) U.S. Cl. CPC H04L 51/216; H04L 51/04

(57) ABSTRACT

The purpose of the present disclosure is to provide a message transmission device that transmits a message that is easy to open.

In a message transmission device 100 of the present disclosure, a reception unit 101 receives smartphone log data from a user terminal 200. A message generation unit 105 performs a process of transmitting a transmission message based on the smartphone log data and the opening history of messages in the user terminal 200. This message transmission process includes a process of generating a message based on the smartphone log data and the opening history. For example, the message generation unit 105 selects a nudge that is based on the smartphone log data and the opening history, and generates and transmits a message that corresponds to the nudge.

### TECHNICAL FIELD

The present invention relates to a message transmission device.

### BACKGROUND ART

Patent Literature 1 discloses a message transmission device that transmits a message that corresponds to a user's psychological state or psychological bias.

### CITATION LIST

### Patent Literature

[Patent Literature 1] Japanese Unexamined Patent Publication No. 2022-55712

### SUMMARY OF INVENTION

### Technical Problem

However, even if an appropriate message according to a user's psychological state is sent, the user may not open the message, and the effect of sending an appropriate message may not be obtained.

Consequently, an object of the present invention is to provide a message transmission device that transmits a message that is easy to open.

### Solution to Problem

According to the present invention, there is provided a message transmission device including: an acquisition unit configured to acquire terminal log data of a user terminal; and a message transmission unit configured to perform a process of transmitting a transmission message based on the terminal log data and an opening history of messages in the user terminal.

### Advantageous Effects of Invention

According to the present invention, it is possible to transmit a message in a way that makes it easier for a user to open the message.

### BRIEF DESCRIPTION OF DRAWINGS

FIG. 1 is a block diagram illustrating a functional configuration of a message transmission device 100 of the present disclosure.

FIG. 2 is a diagram illustrating a specific example of personality factor scores.

FIG. 3 is a diagram illustrating an opening rate for each nudge type of a user derived by an opening estimation unit 103.

FIG. 4 is a diagram illustrating an opening rate for each nudge type. FIG. 5(a) is a diagram illustrating a specific example of an opening DB 104a, and FIG. 5(b) is a diagram illustrating a delivery status obtained from the opening DB 104a.

FIG. 6 is a diagram illustrating a specific example of a nudge message DB 103b relating to walking.

FIG. 7 is a schematic diagram illustrating a learning process of a personality factor score estimation model 102a.

FIG. 8 is a diagram illustrating a specific example of a personality factor score DB 102c.

FIG. 9 is a schematic diagram illustrating a learning process of an opening estimation model 103a.

FIG. 10 is a flowchart illustrating operations of the message transmission device 100.

FIG. 11 is a diagram illustrating an example of a hardware configuration of the message transmission device 100 according to an embodiment of the present disclosure.

### DESCRIPTION OF EMBODIMENTS

An embodiment of the present disclosure will be described with reference to the accompanying drawings. The same components are denoted, if possible, by the same reference numerals and signs, and thus description thereof will not be repeated.

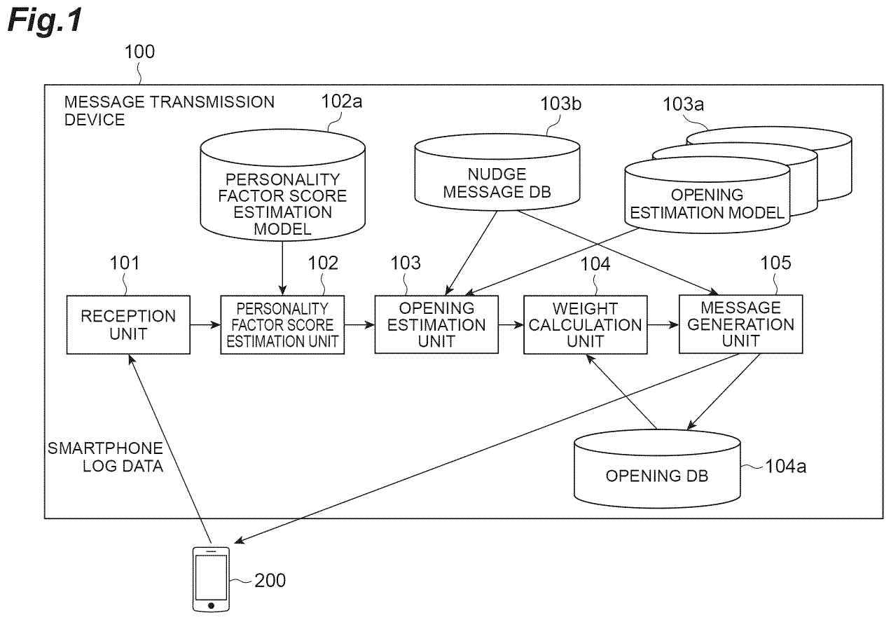

FIG. 1 is a block diagram illustrating a functional configuration of a message transmission device 100 of the present disclosure. The message transmission device 100 receives smartphone log data from a user terminal 200 and transmits a message that corresponds thereto.

In the present disclosure, the user terminal 200 has, for example, a healthcare application (hereinafter, the application will be abbreviated as an app) and has a function of counting the number of steps taken by a user and notifying the user of the number of steps and a target number of steps. The user terminal 200 transmits a target application and smartphone log data to the message transmission device 100 as a request for transmitting a message periodically or at a predetermined timing. The timing of notification involves delivering a message by taking into account factors such as a time, a location, or a person who is with the user on that occasion, which makes it more likely for the user to respond.

The message transmission device 100 transmits a message relating to the number of steps, a target number of steps, or the like to the user terminal 200 in accordance with the application and smartphone log data. The message transmission device 100 then generates and transmits a message of which the content is easy for a user to open, or transmits the message at a timing at which it is easy for the user to open it.

Meanwhile, in the present disclosure, the message transmission device 100 is disclosed as transmitting a healthcare-related message such as a target number of steps, but there is no limitation thereto. Any message that prompts a user to take a predetermined action need only be transmitted. For example, the user terminal 200 may have a shopping application, and the message transmission device 100 may send a message that prompts the user to take a purchase action.

Hereinafter, the details of the message transmission device 100 will be described. The message transmission device 100 is configured to include a reception unit 101, a personality factor score estimation unit 102, an opening estimation unit 103, a weight calculation unit 104, a message generation unit 105, a personality factor score estimation model 102a, an opening estimation model 103a, a nudge message DB 103b, and an opening DB 104a.

The reception unit 101 is a unit that receives the application type (or application ID) which is a target for a message and smartphone log data from the user terminal 200 at a predetermined timing or periodically. The application type (or application ID) is information for identifying an application such as, for example, a healthcare application, and the healthcare application is an application that counts the number of steps taken by a user or the like and notifies the user of the number of steps or notifies the user of a target number of steps or the like.

The smartphone log data includes user attribute information, application logs, position information, subscriber information, healthcare logs, and message opening information at a certain point in time. This smartphone log data is data for the most recent predetermined period at the user terminal 200. The smartphone log data is stored in the opening DB 104a for use as data for learning to be described later.

The attribute information includes a user's gender, age, annual income, occupation, hobbies, and the like. The application log is a usage log of applications registered in the user terminal 200. Descriptive statistics are shown for each application and for each category thereof with respect to the usage time, the interval between usage times, and the number of uses. The applications include phone, email, SMS, messaging applications, SNS, and the like.

The position information indicates a position obtained by the GPS or the like of the user terminal 200. In addition, it includes descriptive statistics relating to the travel distance, the travel route, and the stay points. The travel route and the stay points may include at least one of the similarity, the means of travel, the duration of stay, and the at-home rate. The similarity indicates the degree of match compared with the travel route and the stay points of a user in the past.

The subscriber information is information on a user who has made a contract for the user terminal 200. For example, the information includes a fee plan, a model change cycle, contract options, and the like.

The healthcare log is information indicating the health condition of a user, such as a BMI, the number of steps at the current point in time, the target number of steps, and the average number of steps. This information is information obtained by the user terminal 200 or a wearable terminal linked thereto.

The message opening information is information about the opening of messages transmitted to the user terminal 200, such as the opening rate, the opening time, and whether or not the previous message was opened. The opening time is a time when a user opened the message (in YYYYMMDDhhmm format) and a time from when the message arrived to when the message was opened.

The personality factor score estimation unit 102 is a unit that estimates the personality factor scores of a user on the basis of smartphone log data acquired in real time. The personality factor score estimation unit 102 inputs smartphone log data to the personality factor score estimation model 102a and acquires personality factor scores which are the output results. The personality factor scores are standardized numerical information indicating the personality or psychological characteristics of the user.

The personality factor score estimation model 102a is an estimation model trained through known machine learning, using smartphone log data for learning as explanatory variables and personality factor scores for learning as objective variables. In the present disclosure, the personality factor score is assumed to include at least one of BigFive, Health Locus of Control, and a time discount rate, but may include other factors or indicate psychological characteristics of the user other than these factors.

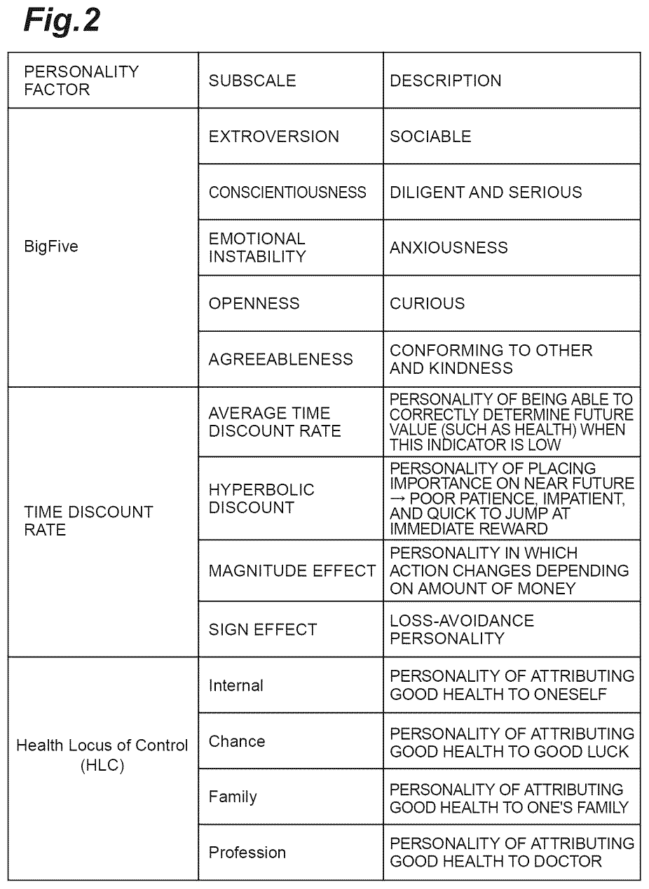

A specific example of these personality factor scores is shown in FIG. 2. BigFive is an idea (theory) that personality is composed of five factors. In the present disclosure, the five factors are openness, conscientiousness, extroversion, agreeableness, and emotional instability. It is believed that the strength or weakness of these five factors makes a difference in the personality and behavior of the user.

Health Locus of Control is an idea of classifying where to seek the cause of health-related evaluation in oneself or in others. The tendency to seek the cause in oneself is classified as internal locus of control, while the tendency to seek the cause in others or the external environment is classified as external locus of control.

The time discount rate is also referred to as the time preference rate. The time discount rate indicates how much lower the future value of a certain reward (delayed reward) is perceived to be than the current value (immediate reward) as the discount rate by time, and the discount rate.

The opening estimation unit 103 is a unit that acquires a predicted opening rate for each nudge message (nudge type) prepared in advance in the nudge message DB 103b on the basis of the estimated personality factor scores, attribute information, and delivery status. In the present disclosure, the opening estimation unit 103 inputs the personality factor scores, attribute information, and delivery status to the opening estimation model 103a, and derives a predicted opening rate for each nudge type of the user. Meanwhile, the delivery status is not essential.

The opening estimation model 103a is prepared for each nudge type, and the opening estimation unit 103 inputs the personality factor scores and the attribute information to each of the opening estimation models 103a and derives a predicted opening rate from each.

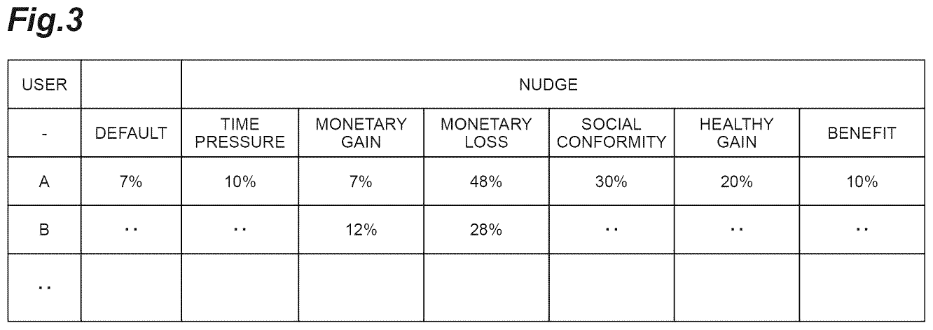

FIG. 3 is a diagram illustrating an opening rate for each nudge type of a user derived by the opening estimation unit 103. FIG. 3 shows an opening rate for each nudge type of a plurality of user, but it is sufficient to show an opening rate for one target user. In FIG. 3, the opening rate of nudge messages of the type of monetary gain for user A is 7%, the opening rate of nudge messages of monetary loss is 48%, and the like. For this user A, it can be understood that sending a nudge message of monetary loss is effective.

Here, the nudge type will be described. Meanwhile, the default is a message which is not a nudge.

Time pressure is the concept of a nudge in which a sense of time pressure deprives a user of his/her ability to make a calm decision and encourages the user to take action. In the present disclosure, it involves prompting a user to take a predetermined action by showing the remaining time until the achievement of a goal.

Monetary gain and monetary loss are the concept of a nudge that prompts a user to take a predetermined action by presenting an economic gain or loss.

Social conformity is the concept of a nudge that prompts a user to take a predetermined action because people tend to align the actions of those around them. In the present disclosure, the user is prompted to walk by showing the state (here, the number of steps) of other users.

Healthy gain is the concept of a nudge that indicates prompting a user to take a predetermined action by presenting a healthy gain or loss.

Benefit is the concept of a nudge that indicates prompting a user to take a predetermined action by showing the user a positive benefit obtained from a certain product, action, or health.

The nudge message for each nudge type will be described later.

The weight calculation unit 104 is a unit that performs a weighting process by multiplying the predicted opening rate calculated by the opening estimation unit 103 by the “message opening rate up to now” (hereinafter referred to as past opening rate) of a target user. The weight calculation unit 104 refers to the opening DB 104a to calculate the opening rate for each nudge type and acquire this as a past opening rate.

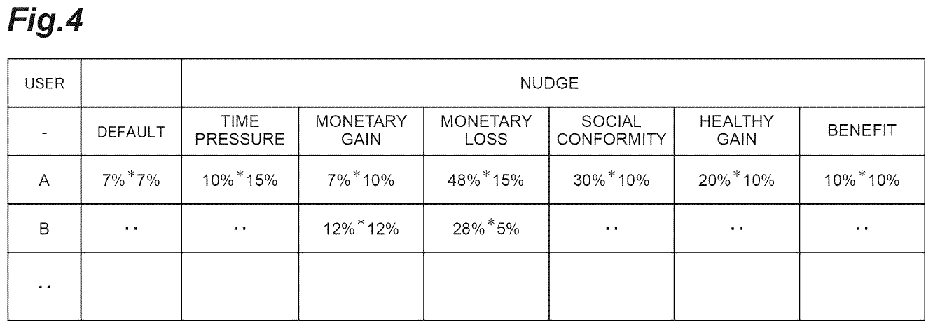

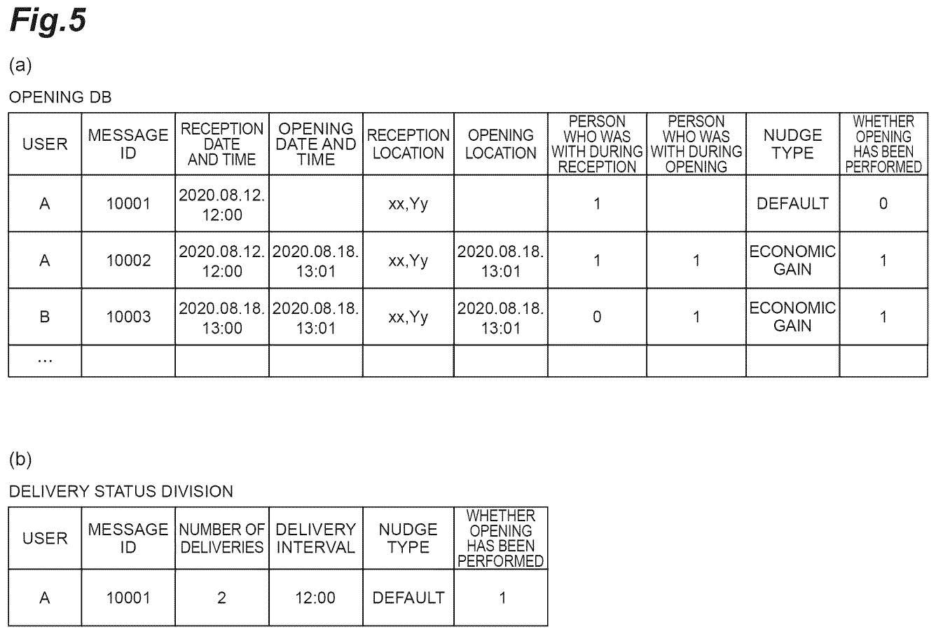

FIG. 4 is a diagram illustrating an opening rate for each nudge type. As shown in the drawing, the probability that a user will open a message is obtained by multiplying the predicted opening rate by the past opening rate. For example, in FIG. 4, the past opening rate of the default message is 7%, and by multiplying this by the predicted opening rate 7%, the probability that the final user will open it can be obtained.

The weight calculation unit 104 performs a weight process on the basis of the past opening rate, but there is no limitation thereto. The weight calculation unit 104 may multiply the predicted opening rate by a predetermined weight coefficient depending on a time, a location, or a person who is with the user. For example, since it is assumed that a user will be short on time during the time slot in the morning (predetermined time slot), the user tends to open or not open the message depending on or regardless of the nudge type. Thus, the weight coefficient is set to be high for a time slot when it is easy to open a message, and conversely, the weight coefficient is set to be low for a nudge type during a time slot when it is difficult to open a message.

Here, the weight coefficient focusing on time has been described, but the weight coefficient may be changed depending on the location and who is with the user. The location and person who is with the user may be included in the smartphone log data transmitted from the user terminal 200. The position information is acquired using a GPS or the like at the user terminal 200. In addition, the user terminal 200 can ascertain nearby users (other user terminals) by using near field communication or the like.

In addition, the opening rate according to the time slot, location, who was with whom, personality factor scores of a person who was with, and the like may be calculated from the opening DB 104a, and it may be changed to a weight coefficient and multiplied by the predicted opening rate.

Here, the acquisition of the past opening rate will be described. The weight calculation unit 104 accesses the opening DB 104a and checks whether a user has opened a message. The opening DB 104a stores, for each user, an opening history in which the nudge type of a message is associated with whether the message has been opened.

FIG. 5(a) is a diagram illustrating a specific example of the opening DB 104a. As shown in the drawing, the opening DB 104a stores, for each user, history information such as a message ID, a reception date and time, an opening date and time, a reception location, an opening location, whether there has been a person who was with during reception, whether there has been a person who was with during opening, a nudge type, and whether opening has been performed, and the like in association with each other. In addition, the personality factor scores of a person who was with may also be stored as necessary in association therewith. These scores can be tallied for each user to obtain the opening rate for each nudge type.

This opening DB 104a is configured by receiving, from the user terminal 200, the opening result, the opening date and time, the opening location, information on whether there has been a person who was with during opening, and the like each time a nudge message is transmitted. The nudge type is stored when the message transmission device 100 transmits the nudge message. In addition, as for the information on whether someone has been with, an opening DB management device (not shown) refers to a position registration server that manages the position of each user terminal on the basis of the position of the user terminal 200 and the time to determine whether another terminal has been near the user terminal 200, make a determination on the basis of that, and register it in the opening DB 104a.

At that time, the opening DB management device can acquire which user terminal 200 (who) was present and the personality factor score of the user from a personality factor score DB 102c, and reflect this in the opening DB 104a.

The weight calculation unit 104 can refer to the opening DB 104a to obtain the opening rate for each user and for each nudge type. Meanwhile, the individual opening rate is defined as, but not limited to, a rate at which a message is received and then opened with a predetermined time. In addition, the location or who was with whom can also be considered. That is, in addition to or instead of the time or nudge type, the opening rate in a certain location may be obtained, or the opening rate in a case where who was with whom (or was not with) may be obtained. The opening rate may be obtained by appropriately combining the nudge type, time, location, who was with whom, and the like.

The weight calculation unit 104 may determine what state the user is in (position, whether to be with someone) on the basis of the user's position registration information (such as a position registration DB) provided by a server that manages the user's position information or the like, determine what weight to multiply, and perform the weighting process.

In addition, the weight calculation unit 104 may use the opening rate calculated in accordance with to the time, position, whether someone has been with, and the like. The weight calculation unit 104 may calculate the opening rate using the opening DB 104a.

The message generation unit 105 is a unit that generates a nudge message on the basis of the opening rate calculated by the weight calculation unit 104 and transmits the nudge message to the user terminal 200. For example, the message generation unit 105 selects the nudge type with the highest opening rate and generates a message based on it.

In the present disclosure, the message generation unit 105 generates a message that corresponds to an application of the user terminal 200. In the case of a healthcare application in the user terminal 200, a message relating to walking is retrieved from the nudge message DB 103b and generated. The reception unit 101 also receives a target value and a numerical value at a current point in time (the target number of steps and the number of steps at a current point in time in the case of walking) from the user terminal 200, and the message generation unit 105 generates a nudge message accordingly as necessary. Meanwhile, the target value and the like are not necessarily required.

In addition, the message generation unit 105 has a function of receiving the opening result and the like from the user terminal 200 within a predetermined time when a message is transmitted and reflecting them in the opening DB 104a.

Meanwhile, in the present disclosure, when a message is received, the user terminal 200 displays the message as a banner. This makes it possible for the user to view a part of the message. Therefore, in accordance with a nudge, the user may open the message to view it in its entirety.

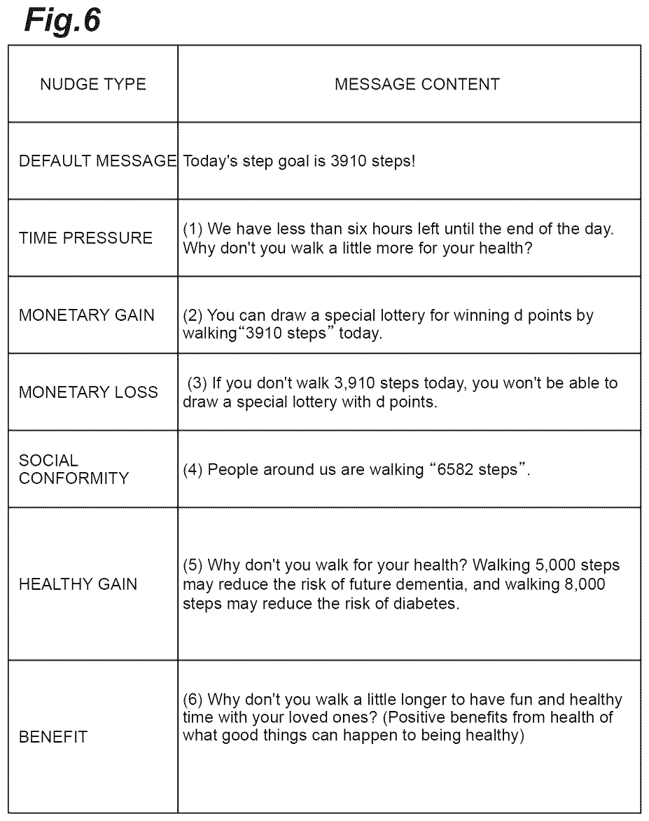

FIG. 6 is a diagram illustrating a specific example of the nudge message DB 103b relating to walking. As shown in the drawing, the nudge message DB 103b stores, for one user action, a nudge type according to the user's personality factor score in addition to the default message. FIG. 6 shows nudge types such as time pressure and monetary gain in addition to the default message as a message to prompt walking such as “Walking goal is 3910 steps.”

In FIG. 6, the default message simply indicates the target value. This target value is a value determined for each user on the basis of the smartphone log data received by the reception unit 101. When indicating a target value for the number of steps, the target value is set to a value obtained by subtracting the number of steps taken up to that point in time from the number of steps taken in that day. The target value is determined on the basis of the average or median of the user's daily actions, and may be, for example, the average number of steps.

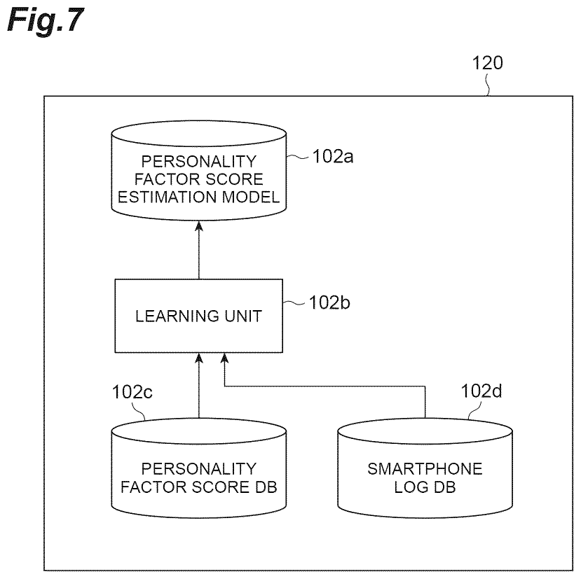

Next, the learning process of the personality factor score estimation model 102a will be described. FIG. 7 is a schematic diagram illustrating a learning device 120 that trains the personality factor score estimation model 102a. As shown in the drawing, the learning device 120 includes a learning unit 102b, the personality factor score DB 102c, and a smartphone log DB 102d, and uses these components to generate the personality factor score estimation model 102a.

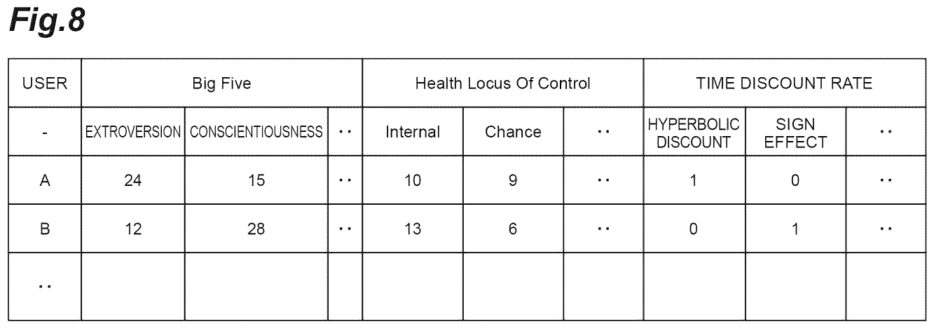

The personality factor score DB 102c is a database that stores the personality factor scores for each user. The personality factor scores are data for learning stored in the personality factor score DB 102c. This information is acquired in advance for each user through a questionnaire or the like. FIG. 8 is a diagram illustrating a specific example of the personality factor score DB 102c. As shown in the drawing, a score is assigned for each user and for each subscale of the personality factor score.

In addition, the smartphone log DB 102d stores smartphone log data for each user. The smartphone log data indicates user attribute information, application logs, position information, and the like as described above. The smartphone log DB 102d stores data for each predetermined time slot.

The learning unit 102b generates the personality factor score estimation model 102a by performing learning through known machine learning using smartphone log data in a predetermined time slot as explanatory variables and using the personality factor scores as objective variables.

Each of these components is included in the learning device 120, and at a predetermined timing, the learning device 120 updates the personality factor score estimation model 102A.

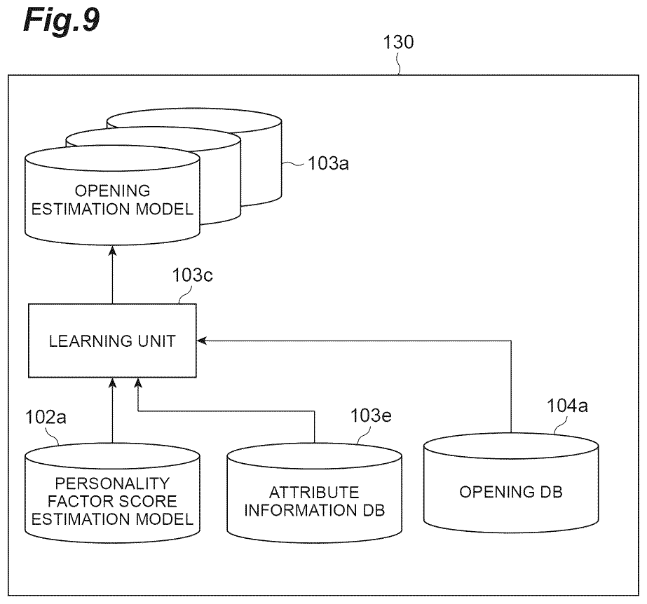

Next, the learning process of the opening estimation model 103a will be described. FIG. 9 is a block diagram of a learning device 130 that performs the learning process of the opening estimation model 103a. As shown in the drawing, the learning device 130 includes a learning unit 103c, the personality factor score estimation model 102a, an attribute information DB 103e, and the opening DB 104a, and uses these components to generate the opening estimation model 103a. The learning unit 103c generates the opening estimation model 103a through known machine learning using the estimation value for each user from the personality factor score estimation model 102a, the attribute information for each user stored in the attribute information DB 103e, and the delivery status (the number of deliveries, delivery interval) of a message delivered to each user during delivery as explanatory variables and using whether the message has been opened as an objective variable. Meanwhile, although the personality factor score DB 102c may be used instead of the personality factor score estimation model 102a, information on a larger number of users can be used as explanatory variables by using the personality factor score estimation model 102a.

In addition, in order to perform learning for each nudge type, the learning unit 103c acquires the delivery status of a message for each nudge type and whether the message has been opened. The learning unit 103c then performs machine learning, for each nudge type, using personality factor score information, attribute information, and the delivery status of the nudge message as explanatory variables and using whether the message has been opened as an objective variable, and generates a plurality of opening estimation models 103a corresponding to the nudge type.

As shown in FIG. 5(b), the delivery status of a message is a status determined for each message, and indicates the number of deliveries and the delivery interval immediately before the delivered message. The number of deliveries is the number of messages delivered in the past six months to one year, but the period is an example and there is no limitation thereto. The delivery interval indicates a time interval with the most recently delivered message. If the immediately preceding message was delivered one day ago, it is written as one day, 24 hours, 86400 seconds, or the like. Once the concept of time is understood, there are no limitations on the form of notation. Meanwhile, here, the number of messages delivered and the delivery interval indicate the number of deliveries up to the last message and the time interval between messages of all nudges delivered immediately before, regardless of the nudge type, but may apply to messages of the same nudge type.

The information on the delivery status is acquired on the basis of the opening DB 104a shown in FIG. 5(a). That is, the opening DB 104a stores information on the status from reception to opening for each message and whether the message has been opened, and the delivery status is acquired on the basis of this information.

The attribute information DB 103e is a database that stores user attribute information.

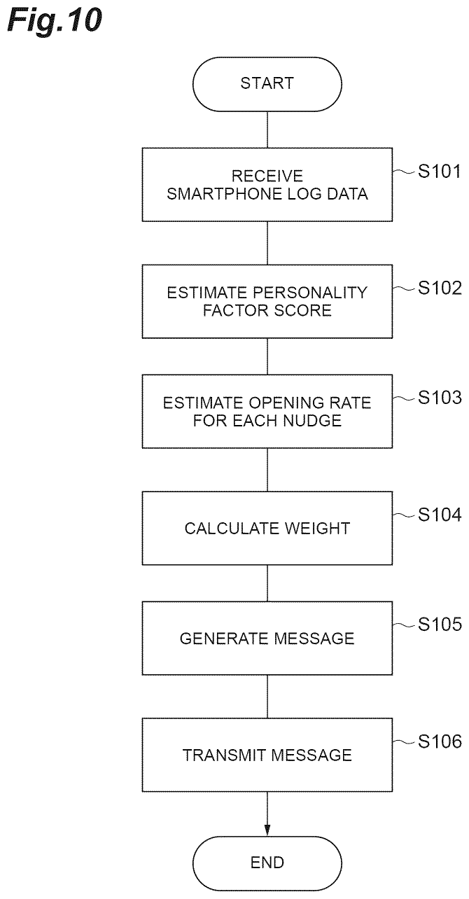

The operation of the message transmission device 100 configured in this way will be described below. FIG. 10 is a flowchart illustrating operations of the message transmission device 100. The reception unit 101 receives smartphone log data from the user terminal 200 (S101). The personality factor score estimation unit 102 inputs the received smartphone log data to the personality factor score estimation model 102a and estimates the personality factor scores of the user of the user terminal 200 (S102).

The opening estimation unit 103 inputs the personality factor scores of the user to the opening estimation model 103a and estimates the opening rate for each nudge type (S103).

The weight calculation unit 104 performs the weighting process by multiplying the opening rate for each nudge type by the past opening rate of the user (S104).

The message generation unit 105 selects one nudge type on the basis of the opening rate for each nudge type on which the weighting process has been performed, generates a message that corresponds to the nudge type (S105), and transmits the message to the user terminal 200 (S106).

In this way, it is possible to transmit a message of a nudge type which is easy for a user to open.

Next, a modification example will be described. In the above disclosure, the message transmission device 100 includes the personality factor score estimation model 102a and the opening estimation model 103a, but these components may be integrated into one estimation model.

This estimation model is trained through machine learning using the smartphone log data as explanatory variables and using whether the message has been opened as an objective variable. As data for learning, a database in which the smartphone log data and whether the message has been opened for each nudge type are stored is prepared for each user. This database is periodically uploaded from the user terminal 200 or obtained by an opening notification in response to the transmission of the above message.

In the above disclosure, the personality factor scores are first calculated and the opening rate is obtained on the basis of these scores, but this modification example differs in that the personality factor scores are omitted. Meanwhile, as shown in the above disclosure, a method of estimating the personality factor scores once and then estimating the opening rate is considered to be more accurate.

In addition, in the above disclosure, the opening rate is obtained for each nudge type, the nudge type with the highest opening rate is obtained, and a message based on that is generated and transmitted, but there is no limitation thereto.

For example, since the opening rate varies depending on the position of the user terminal 200, the delivery time of a message, and the status of the user terminal 200 (whether to be with someone), the opening rate may be estimated accordingly regardless of whether the message is a nudge message.

In the above disclosure, the opening estimation model 103a is prepared for each nudge type, and the opening rate is output for each nudge type, but there is no limitation thereto. For example, the opening estimation model 103a may be prepared for each position, time, or status of the user terminal 200.

In this case, the above learning process is performed for each time the message was delivered to the user, the position of the user terminal 200 during deliver, and the status of the user terminal 200 during deliver (such as who was with whom). The above position may be classified into broad concepts such as home, workplace, downtown, and others.

The learning unit 103c retrieves information on whether the message has been opened for each of the position, time, or status. The learning unit 103c generates the opening estimation model 103a through known machine learning using personality factor score information, attribute information, and the delivery status (the number of deliveries, the delivery interval) of the message delivered to each user during delivery as explanatory variables and using whether the message has been opened as an objective variable.

In this way, the opening estimation model 103a may be prepared for each delivery time, for each position of the user terminal 200, or for each status of the user terminal 200, and each opening rate may be obtained.

Next, the operational effects of the message transmission device 100 of the present disclosure will be described. In the message transmission device 100 of the present disclosure, the reception unit 101 receives the smartphone log data of the user terminal 200. The message generation unit 105 performs a process of transmitting a transmission message based on the smartphone log data and the opening history of messages (the opening DB 104a) in the user terminal 200. The process of transmitting a transmission message referred to here includes generating an appropriate message or determining an appropriate transmission timing of the message.

According to this configuration, it is possible to perform a process of transmitting a transmission message which is easy for a user to open on the basis of the history (such as whether opening has been performed) stored in the opening DB 104a. As a result, the rate of opening performed by a user is improved. The opening history includes at least the user ID in the opening DB 104a and whether the message has been opened by the user, and other information is not necessarily required.

This message transmission process includes a process of generating a message based on the smartphone log data and the opening history. For example, the message generation unit 105 selects a nudge that is based on the smartphone log data and the opening history (for example, the highest opening rate), and generates and transmits a message that corresponds to the nudge.

This configuration makes it possible to generate a message that is easy for a user to open. A user may or may not open a message easily depending on the message content (nudge type). By generating a message based on the opening history, it is possible to generate a message that is easy for a user to open.

In addition, the message transmission process includes a process of transmitting a message at a timing based on the smartphone log data and the opening history of messages. For example, the message generation unit 105 determines a timing based on the smartphone log data and the opening history, and transmits a predetermined message at the timing. The timing of opening may differ depending on the smartphone log data and the opening history in the user terminal 200, and the timing of opening may differ depending on users such as users who tend to open in the morning and users who tend to open in the evening.

In addition, the message transmission process includes a process of transmitting a message at a timing based on the state of the user terminal 200 in addition to the smartphone log data and the opening history. For example, the state of the user terminal 200 indicates the position of the user terminal, a state of being with another user, or the like. The message generation unit 105 generates and transmits a message at a timing according to the state.

In addition, the message generation unit 105 performs a process of transmitting a transmission message on the basis of an estimation model trained on the basis of the smartphone log data prepared for learning and the opening history of messages. This configuration makes it possible to enable a process of transmitting a message that is easy to open from the smartphone log. This estimation model may be trained only from the smartphone log and the opening history, or may take other information into consideration.

For example, the estimation model includes the personality factor score estimation model 102a generated through machine learning using the terminal log data prepared for learning as explanatory variables and using the user's personality factor scores prepared for learning as objective variables.

In addition, this estimation model includes the opening estimation model 103a generated through machine learning using the user's personality factors prepared for learning as explanatory variables and using the opening history of messages prepared for learning as an objective variable. The personality factors include at least one of BigFive, Health Locus of Control, and a time discount rate.

In addition, the estimation model outputs the opening rate for each nudge type and for each other predetermined condition, and the message generation unit 105 generates a transmission message (or performs transmission at a predetermined timing) on the basis of the opening rate from the estimation model. The predetermined condition includes the time of transmission, the user's location during transmission, the user's status (whether to be with someone), and the like.

In addition, the message transmission device 100 further includes the weight calculation unit 104 that acquires a past opening rate in the user terminal 200 and performs the weighting process on the opening rate on the basis of the past opening rate. The message generation unit 105 performs a process of transmitting a transmission message on the basis of the opening rate on which the weighting process has been performed.

The message transmission device of the present disclosure has the following configuration.

[1] A message transmission device comprising:
an acquisition unit configured to acquire terminal log data of a user terminal; and
a message transmission unit configured to perform a process of transmitting a transmission message based on the terminal log data and an opening history of messages in the user terminal.

[2] The message transmission device according to [1], wherein the transmission process includes a process of generating a message based on the terminal log data and the opening history.

[3] The message transmission device according to [1] or [2], wherein the transmission process includes a process of transmitting a message at a timing based on the terminal log data and the opening history of messages.

[4] The message transmission device according to [3], wherein the transmission process further includes a process of transmitting a message at a timing based on a state of the user terminal.

[5] The message transmission device according to any one of to [4], wherein the message transmission unit performs the process of transmitting a transmission message on the basis of an estimation model trained on the basis of terminal log data prepared for learning and an opening history of messages.

[6] The message transmission device according to [5], wherein the estimation model is further trained on the basis of personality factors of a user.

[7] The message transmission device according to [6], wherein the estimation model includes a personality factor estimation model generated through machine learning using the terminal log data prepared for learning as explanatory variables and using the personality factors of a user prepared for learning as objective variables.

[8] The message transmission device according to [6], wherein the estimation model includes an opening estimation model generated through machine learning using the personality factors of a user prepared for learning as explanatory variables and using the opening history of messages prepared for learning as an objective variable.

[9] The message transmission device according to any one of [5] to [8], wherein the estimation model outputs an opening rate for each predetermined condition, and
the message transmission unit generates the transmission message on the basis of the opening rate from the estimation model.

[10] The message transmission device according to [9], further comprising a weight calculation unit configured to acquire a past opening rate in the user terminal and perform a weighting process on the opening rate on the basis of the past opening rate,
wherein the message transmission unit performs the process of transmitting a transmission message on the basis of the opening rate on which the weighting process has been performed.

The block diagram used for the description of the above embodiments shows blocks of functions. Those functional blocks (component parts) are implemented by any combination of at least one of hardware and software. Further, a means of implementing each functional block is not particularly limited. Specifically, each functional block may be implemented by one physically or logically combined device or may be implemented by two or more physically or logically separated devices that are directly or indirectly connected (e.g., by using wired or wireless connection etc.). The functional blocks may be implemented by combining software with the above-described one device or the above-described plurality of devices.

The functions include determining, deciding, judging, calculating, computing, processing, deriving, investigating, looking up/searching/inquiring, ascertaining, receiving, transmitting, outputting, accessing, resolving, selecting, choosing, establishing, comparing, assuming, expecting, considering, broadcasting, notifying, communicating, forwarding, configuring, reconfiguring, allocating/mapping, assigning and the like, though not limited thereto. For example, the functional block (component part) that implements the function of transmitting is referred to as a transmitting unit or a transmitter. In any case, a means of implementation is not particularly limited as described above.

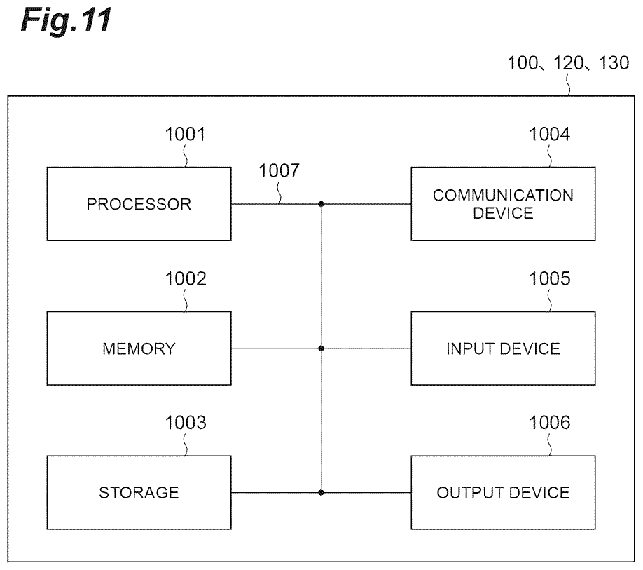

For example, the message transmission device 100 and the like according to one embodiment of the present disclosure may function as a computer that performs processing of a message transmission method or a conversation information generation method according to the present disclosure. FIG. 11 is a view showing an example of the hardware configuration of the message transmission device 100, learning device 120, and learning device 130 (hereinafter referred to as the message transmission device 100) according to one embodiment of the present disclosure. The message transmission device 100 described above may be physically configured as a computer device that includes a processor 1001, a memory 1002, a storage 1003, a communication device 1004, an input device 1005, an output device 1006, a bus 1007 and the like.

In the following description, the term “device” may be replaced with a circuit, a device, a unit, or the like. The hardware configuration of the message transmission device 100 may be configured to include one or a plurality of the devices shown in the drawings or may be configured without including some of those devices.

The functions of the message transmission device 100 may be implemented by loading predetermined software (programs) on hardware such as the processor 1001 and the memory 1002, so that the processor 1001 performs computations to control communications by the communication device 1004 and control at least one of reading and writing of data in the memory 1002 and the storage 1003.

The processor 1001 may, for example, operate an operating system to control the entire computer. The processor 1001 may be configured to include a CPU (Central Processing Unit) including an interface with a peripheral device, a control device, an arithmetic device, a register and the like. For example, the personality factor score estimation unit 102, the opening estimation unit 103, the weight calculation unit 104 and the like described above may be implemented by the processor 1001.

Further, the processor 1001 loads a program (program code), a software module and data from at least one of the storage 1003 and the communication device 1004 into the memory 1002 and performs various processing according to them. As the program, a program that causes a computer to execute at least some of the operations described in the above embodiments is used. For example, personality factor score estimation unit 102 may be implemented by a control program that is stored in the memory 1002 and operates on the processor 1001, and the other functional blocks may be implemented in the same way. Although the above-described processing is executed by one processor 1001 in the above description, the processing may be executed simultaneously or sequentially by two or more processors 1001. The processor 1001 may be implemented in one or more chips. Note that the program may be transmitted from a network through a telecommunications line.

The memory 1002 is a computer-readable recording medium, and it may be composed of at least one of ROM (Read Only Memory), EPROM (ErasableProgrammable ROM), EEPROM (Electrically ErasableProgrammable ROM), RAM (Random Access Memory) and the like, for example. The memory 1002 may be also called a register, a cache, a main memory (main storage device) or the like. The memory 1002 can store a program (program code), a software module and the like that can be executed for implementing a message transmission method according to one embodiment of the present disclosure.

The storage 1003 is a computer-readable recording medium, and it may be composed of at least one of an optical disk such as a CD-ROM (Compact Disk ROM), a hard disk drive, a flexible disk, a magneto-optical disk (e.g., a compact disk, a digital versatile disk, and a Blu-ray (registered trademark) disk), a smart card, a flash memory (e.g., a card, a stick, and a key drive), a floppy (registered trademark) disk, a magnetic strip and the like, for example. The storage 1003 may be called an auxiliary storage device. The above-described storage medium may be a database, a server, or another appropriate medium including at least one of the memory 1002 and/or the storage 1003, for example.

The communication device 1004 is hardware (a transmitting and receiving device) for performing communication between computers via at least one of a wired network and a wireless network, and it may also be referred to as a network device, a network controller, a network card, a communication module, or the like. The communication device 1004 may include a high-frequency switch, a duplexer, a filter, a frequency synthesizer or the like in order to implement at least one of FDD (Frequency Division Duplex) and TDD (Time Division Duplex), for example. For example, the above-described reception unit 101 and the message generation unit 105 or the like may be implemented by the communication device 1004. The communication device 1004 may be implemented in such a way that a transmitting unit and a receiving unit are physically or logically separated.

The input device 1005 is an input device (e.g., a keyboard, a mouse, a microphone, a switch, a button, a sensor, etc.) that receives an input from the outside. The output device 1006 is an output device (e.g., a display, a speaker, an LED lamp, etc.) that makes output to the outside. Note that the input device 1005 and the output device 1006 may be integrated (e.g., a touch panel).

In addition, the devices such as the processor 1001 and the memory 1002 are connected by the bus 1007 for communicating information. The bus 1007 may be a single bus or may be composed of different buses between different devices.

Further, the message transmission device 100 may include hardware such as a microprocessor, a DSP (Digital Signal Processor), an ASIC (Application Specific Integrated Circuit), a PLD (Programmable Logic Device), and an FPGA (Field Programmable Gate Array), and some or all of the functional blocks may be implemented by the above-described hardware components. For example, the processor 1001 may be implemented with at least one of these hardware components.

Notification of information may be made by another method, not limited to the aspects/embodiments described in the present disclosure. For example, notification of information may be made by physical layer signaling (e.g., DCI (Downlink Control Information), UCI (Uplink Control Information)), upper layer signaling (e.g., RRC (Radio Resource Control) signaling, MAC (Medium Access Control) signaling, annunciation information (MIB (Master Information Block), SIB (System Information Block))), another signal, or a combination of them. Further, RRC signaling may be called an RRC message, and it may be an RRC Connection Setup message, an RRC Connection Reconfiguration message or the like, for example.

The procedure, the sequence, the flowchart and the like in each of the aspects/embodiments described in the present disclosure may be in a different order unless inconsistency arises. For example, for the method described in the present disclosure, elements of various steps are described in an exemplified order, and it is not limited to the specific order described above.

Input/output information or the like may be stored in a specific location (e.g., memory) or managed in a management table. Further, input/output information or the like can be overwritten or updated, or additional data can be written. Output information or the like may be deleted. Input information or the like may be transmitted to another device.

The determination may be made by a value represented by one bit (0 or 1), by a truth-value (Boolean: true or false), or by numerical comparison (e.g., comparison with a specified value).

Each of the aspects/embodiments described in the present disclosure may be used alone, may be used in combination, or may be used by being switched according to the execution. Further, a notification of specified information (e.g., a notification of “being X”) is not limited to be made explicitly, and it may be made implicitly (e.g., a notification of the specified information is not made).

Although the present disclosure is described in detail above, it is apparent to those skilled in the art that the present disclosure is not restricted to the embodiments described in this disclosure. The present disclosure can be implemented as a modified and changed form without deviating from the spirit and scope of the present disclosure defined by the appended claims. Accordingly, the description of the present disclosure is given merely by way of illustration and does not have any restrictive meaning to the present disclosure.

Software may be called any of software, firmware, middleware, microcode, hardware description language or another name, and it should be interpreted widely so as to mean an instruction, an instruction set, a code, a code segment, a program code, a program, a sub-program, a software module, an application, a software application, a software package, a routine, a sub-routine, an object, an executable file, a thread of execution, a procedure, a function and the like.

Further, software, instructions and the like may be transmitted and received via a transmission medium. For example, when software is transmitted from a website, a server or another remote source using at least one of wired technology (a coaxial cable, an optical fiber cable, a twisted pair and a digital subscriber line (DSL) etc.) and wireless technology (infrared rays, microwave etc.), at least one of those wired technology and wireless technology are included in the definition of the transmission medium.

The information, signals and the like described in the present disclosure may be represented by any of various different technologies. For example, data, an instruction, a command, information, a signal, a bit, a symbol, a chip and the like that can be referred to in the above description may be represented by a voltage, a current, an electromagnetic wave, a magnetic field or a magnetic particle, an optical field or a photon, or an arbitrary combination of them.

Note that the term described in the present disclosure and the term needed to understand the present disclosure may be replaced by a term having the same or similar meaning. For example, at least one of a channel and a symbol may be a signal (signaling). Further, a signal may be a message. Furthermore, a component carrier (CC) may be called a cell, a frequency carrier, or the like.

Further, information, parameters and the like described in the present disclosure may be represented by an absolute value, a relative value to a specified value, or corresponding different information. For example, radio resources may be indicated by an index.

The names used for the above-described parameters are not definitive in any way. Further, mathematical expressions and the like using those parameters are different from those explicitly disclosed in the present disclosure in some cases. Because various channels (e.g., PUCCH, PDCCH etc.) and information elements (e.g., TPC etc.) can be identified by every appropriate names, various names assigned to such various channels and information elements are not definitive in any way.

In the present disclosure, the terms such as “Mobile Station (MS)” “user terminal”, “User Equipment (UE)” and “terminal” can be used to be compatible with each other.

The mobile station can be also called, by those skilled in the art, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client or several other appropriate terms.

Note that the term “determining” and “determining” used in the present disclosure includes a variety of operations. For example, “determining” and “determining” can include regarding the act of judging, calculating, computing, processing, deriving, investigating, looking up/searching/inquiring (e.g., looking up in a table, a database or another data structure), ascertaining or the like as being “determined” and “determined”. Further, “determining” and “determining” can include regarding the act of receiving (e.g., receiving information), transmitting (e.g., transmitting information), inputting, outputting, accessing (e.g., accessing data in a memory) or the like as being “determined” and “determined”. Further, “determining” and “determining” can include regarding the act of resolving, selecting, choosing, establishing, comparing or the like as being “determined” and “determined”. In other words, “determining” and “determining” can include regarding a certain operation as being “determined” and “determined”. Further, “determining (determining)” may be replaced with “assuming”, “expecting”, “considering” and the like.

The term “connected”, “coupled” or every transformation of this term means every direct or indirect connection or coupling between two or more elements, and it includes the case where there are one or more intermediate elements between two elements that are “connected” or “coupled” to each other. The coupling or connection between elements may be physical, logical, or a combination of them. For example, “connect” may be replaced with “access”. When used in the present disclosure, it is considered that two elements are “connected” or “coupled” to each other by using at least one of one or more electric wires, cables, and printed electric connections and, as several non-definitive and non-comprehensive examples, by using electromagnetic energy such as electromagnetic energy having a wavelength of a radio frequency region, a microwave region and an optical (both visible and invisible) region.

The description “on the basis of” used in the present disclosure does not mean “only on the basis of” unless otherwise noted. In other words, the description “on the basis of” means both of “only on the basis of” and “at least on the basis of”.

When the terms such as “first” and “second” are used in the present disclosure, any reference to the element does not limit the amount or order of the elements in general. Those terms can be used in the present disclosure as a convenient way to distinguish between two or more elements. Thus, reference to the first and second elements does not mean that only two elements can be adopted or the first element needs to precede the second element in a certain form.

As long as “include”, “including” and transformation of them are used in the present disclosure, those terms are intended to be comprehensive like the term “comprising”. Further, the term “or” used in the present disclosure is intended not to be exclusive OR.

In the present disclosure, when articles, such as “a”, “an”, and “the” in English, for example, are added by translation, the present disclosure may include that nouns following such articles are plural.

In the present disclosure, the term “A and B are different” may mean that “A and B are different from each other”. Note that this term may mean that “A and B are different from C”. The terms such as “separated” and “coupled” may be also interpreted in the same manner.

### REFERENCE SIGNS LIST

100 Message transmission device, 200 User terminal, 101 Reception unit, 102 Personality factor score estimation unit, 103 Opening estimation unit, 104 Weight calculation unit, 105 Message generation unit, 102a Personality factor score estimation model, 103a Opening estimation model, 103b Nudge message DB, 104a Opening DB

1. A message transmission device comprising:
an acquisition unit configured to acquire terminal log data of a user terminal; and
a message transmission unit configured to perform a process of transmitting a transmission message based on the terminal log data and an opening history of messages in the user terminal.

2. The message transmission device according to claim 1, wherein the transmission process includes a process of generating a message based on the terminal log data and the opening history.

3. The message transmission device according to claim 1, wherein the transmission process includes a process of transmitting a message at a timing based on the terminal log data and the opening history of messages.

4. The message transmission device according to claim 3, wherein the transmission process further includes a process of transmitting a message at a timing based on a state of the user terminal.

5. The message transmission device according to claim 1, wherein the message transmission unit performs the process of transmitting a transmission message on the basis of an estimation model trained on the basis of terminal log data prepared for learning and an opening history of messages.

6. The message transmission device according to claim 5, wherein the estimation model is further trained on the basis of personality factors of a user.

7. The message transmission device according to claim 6, wherein the estimation model includes a personality factor estimation model generated through machine learning using the terminal log data prepared for learning as explanatory variables and using the personality factors of a user prepared for learning as objective variables.

8. The message transmission device according to claim 6, wherein the estimation model includes an opening estimation model generated through machine learning using the personality factors of a user prepared for learning as explanatory variables and using the opening history of messages prepared for learning as an objective variable.

9. The message transmission device according to claim 5, wherein the estimation model outputs an opening rate for each predetermined condition, and
the message transmission unit performs the process of transmitting a transmission message on the basis of the opening rate from the estimation model.

10. The message transmission device according to claim 9, further comprising a weight calculation unit configured to acquire a past opening rate in the user terminal and perform a weighting process on the opening rate on the basis of the past opening rate,
wherein the message transmission unit performs the process of transmitting a transmission message on the basis of the opening rate on which the weighting process has been performed.
